(19) United States
(12) Patent Application Publication
(10) Pub. No.: US 2006/0269049 A1
(43) Pub. Date: Nov. 30, 2006

(54) Dual-detector, simulation CT, and real time function imaging

(76) Inventors: Fang-Fang Yin, Chapel Hill, NC (US); Christopher G. Willett, Durham, NC (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(21) Appl. No.: 11/441,703

(22) Filed: May 26, 2006

Related U.S. Application Data
(60) Provisional application No. 60/684,899, filed on May 26, 2005.

(51) Int. Cl. G01D 18/00

(52) U.S. Cl. 378/207

(57) ABSTRACT

A dual simulator/imaging system includes a pair of detector arrangements, preferably orthogonal to each other. In the case of simulation, an x-ray source may be arranged with each detector. The system can also be implemented in radiation therapy, CT or SPECT environments. There is also described a dual-detector simulator, and a dual detector CBCT simulator.

### CROSS REFERENCE TO RELATED APPLICATIONS

This application is related to U.S. Provisional Application Ser. No. 60/684,899 entitled Dual-Detector Simulator, Simulation CT and Real-Time Function Imaging, which was filed May 26, 2005, and to which priority is expressly claimed herein. The disclosure of said prior application Ser. No. 60/684,899 is specifically incorporated in its entirety by reference herein.

### BACKGROUND OF THE INVENTION

1. Field of the Invention

This invention is related to new apparatus and systems to improve the practice of radiation therapy. More specifically, the invention relates to a dual-detector simulator which uses low energy photon beams to define how actual cancer treatment, in particular external beam radiation treatment will be performed. In another aspect, the invention relates to a dual detector cone-beam computerized tomography (CT) simulator to define how actual cancer treatment will be performed. In yet another aspect, the invention relates to a dual detector in-room single photon emission computed tomography (SPECT) system in which in an imaging system, the detectors are modified to detect photon emissions from a patient's body as a radiological pharmaceutical agent is injected into the patient either by IV or by injecting into the tissue.

The SPECT system could be developed in a simulator with dual detectors, a CBCT simulator with dual-detectors, or in the treatment machine with dual detectors

2. Discussion of Prior Art

Radiation therapy techniques involve a number of different approaches that can be used to treat and cure cancer. Each technique varies in the amount of energy (or dose of treatment) and size and shape of the treatment field (or area of treatment). The most common types of radiation treatment techniques available include, but are not limited to: three-dimensional treatment planning; external beam radiation; IMRT (Intensity Modulated Radiation Therapy); stereostatic radiosurgery; prostate seed implants; brachytherapy; and concurrent chemotherapy and radiation therapy.

In the case of, for example, breast cancer treatment, patients often undergo radiation therapy localized on the breast and in particular both throughout the entire breast as well as at specific tumor sites, in many cases after having undergone lumpectomy or partial breast mastectomy. In other cases, where tumor involvement is extensive and a mastectomy has been performed, radiation therapy may be desirable relative to the chest wall and lymph nodes. In yet still another case, radiation therapy may be conducted prior to surgery alone or in combination with chemotherapy in an attempt to reduce the size of the tumor. Most radiation therapy treatments are performed using a megavoltage x-ray source which is produced from a linear accelerator. Such radiation therapy is typically known as external beam radiation and it is desirable that a treatment protocol defining the location to which radiation is delivered be established, for example, with a simulator.

A simulator is a radiographic device that allows a radiation oncologist to map out the intended treatment volume prior to treatment delivery. The simulator duplicates the geometric setup of the treatment unit and allows treatment fields that are measured on the simulator to be reproduced accurately on a linear accelerator. Such simulators typically use a single low intensity (i.e., kV radiation source with a detector) located on an axis relative to the kV source to detect radiation passing through a patient and to provide appropriate imaging. The detector radiation sources are arranged for being moved together along a plane, as is well known to those of ordinary skill in the art, in amounts sufficient to acquire an image. The arrangement is connected to means for acquiring the scanning information and processing the information including display, as well as for controlling means for causing the source/detector pair to move, such as, for example, a conventional motor or drive, as is well known to those of ordinary skill in the art.

Similarly, in the field of computerized tomography (CT) imaging, it is desirable to provide sufficient cone beam CT imaging. Likewise, it also desirable to provide such efficient imaging in the field of stereostatic fluoroscopic imaging and as in the case of single photon emission computed tomography (SPECT) or for positron emission tomography (PET).

A problem with all of these existing systems is that simulators and imaging devices are typically single detector and single x-ray sources. The deficiency of such configurations is that the image cannot be viewed simultaneously at 3-D formats for moving organs, which lack 3-D information for moving organs and require added longer simulation time.

Accordingly, in accordance with the invention described herein, the disadvantages of the prior art are avoided and enhanced systems are provided.

### BRIEF DESCRIPTION OF THE INVENTION

In accordance with a general aspect of the invention, there is provided a dual-detector simulator. In the case of a patient with cancer to be treated with high energy radiation beams, simulation is used to use low energy photon beams to define how the actual treatment will be performed. In accordance with the invention, an additional x-ray tube and detector pair is provided on an axis at an angle to the prior art single x-ray tube and detector configuration, so that 3-D motion information can be directly viewed to improve localization accuracy. In accordance with an application, in cone-beam CT, a second x-ray tube and detector can also be provided in such a system. Yet still further, in the case of SPECT imaging, a pair of SPECT detectors are provided an angle relative to each other along the same plane.

More specifically, in one aspect there is provided a detector simulator for defining protocols for radiation treatment. The detector simulator includes a first x-ray tube capable of emitting imaging radiation along one axis and a first detector arranged opposite the first x-ray tube along the one axis. A second x-ray tube capable of emitting imaging radiation along another axis different from the one axis, in combination with a second detector, is arranged opposite the second x-ray tube along another axis. The two axes are in the same plane and the first x-ray tube, first detector, second x-ray tube and second detector are arranged relative to each other for defining a space for a patient to be scanned. Means such as a motor, drive or other conventional device for moving such tubes and detectors is provided for scanning a patient placed in the space. There is also provided means for acquiring scanning data or information about a patient, and for processing the information to determine a treatment protocol for the patient.

As will be appreciated by those of ordinary skill in the art, such means for acquiring and scanning can be one of many conventional and readily available computer type devices capable of receiving data and programmed to process the data and provide images to a specialist in a manner well known to those or ordinary skill and the art. Such devices are specifically adapted to accommodate images acquired from two detectors.

In yet still another aspect, the invention relates to a simulator similar to the aforementioned simulator for CT imaging, including a dual source detector pair substantially as described in the arrangement with respect to the detector simulator for defining protocols for radiation treatment.

Yet still further, in another aspect the invention relates to a single photon emission computed tomography (SPECT) system including two SPECT detectors arranged along different axis to acquire images from isotopes injected into a patient.

Preferably, in the arrangements for all the systems the axes are arranged at about 45° to about 90° with respect to each other. More preferably, the axes are arranged at about 90° with respect to each other to provide the shortest simulation/scan/image acquisition time in close to real time conditions.

### BRIEF DESCRIPTION OF THE SEVERAL VIEWS OF THE DRAWING

FIG. 1 is a schematic diagram of a dual-detector simulator for determining optimum radiation therapy, for example, for a breast cancer patient; and

FIG. 2 is a schematic diagram of a dual detector CT simulator in accordance with the invention.

FIG. 3 is a schematic diagram of a dual detector treatment machine in accordance with the invention for SPECT imaging.

### DETAILED DESCRIPTION OF THE INVENTION

The invention described herein is applicable in at least three areas to substantially improve the conventional practice of radiation therapy.

A first area involves a dual detector simulator which uses low energy photon beams to define how actual cancer treatment will be performed. An additional x-ray tube and detector pair, is arranged preferably orthogonal, but possibly at an angle of as low as about 45°, to an existing single detector and single x-rays source. Such an arrangement is used so that 3-D motion information can be directly viewed to improve localization accuracy and to substantially reduce patient simulation time. Tomographic images could be generated using either one detector or dual detectors. The dual detector configuration could be used to generate SPECT images or in combination of CT/SPECT images. SPECT images could be generated using a single detector, but the efficiency could be improved twice with two detectors.

In a second configuration, dual-detector cone beam CT simulator conventionally uses low energy photon beams to define how actual cancer treatment will be performed. In accordance with the invention there is provided an additional x-ray tube and detector orthogonal to the existing CT simulators so that 3-D anatomical as well as motion information can be directly viewed to improve localization accuracy and reduce patient simulation time. Tomographic images could be generated using either one detector or dual detectors. The dual detector configuration could be used to generate SPECT images or in combination of CT/SPECT images. SPECT images could be generated using a single detector, but the efficiency could be improved twice with two detectors. This system could be also used for interventional radiology for real-time biopsy procedures, etc.

In a third aspect, there is provided a dual-detector in-room SPECT system implemented on conventional treatment units which typically include a high-energy photon beam with a portal imaging device, and in which an additional feature is added to enhance localization accuracy through the use of kV x-ray tubes and detectors orthogonally mounted to the treatment gantry. In accordance with the invention, while such a device is used only for treatment localization and verification purposes, the detector is modified for functional imaging purposes whereas both detectors will be used for detecting photons emitting from the patient's body as a radio pharmaceutical agent is injected into the patient either by IV or by injection into the tissue. Collimators are added to both detectors and a reconstruction algorithm provided to reconstruct detected images in a manner conventional and well know to those or ordinary skill in art once the dual detector system is implemented.

In accordance with the invention, there is provided a next generation volume simulator for performing cone-beam CT imaging, stereostatic fluoroscopic imaging and dual detector x-ray plane imaging. In such systems, a patient will lie on a simulator couch, x-ray images can be taken using either radiographic techniques with traditional x-ray imaging or fluoroscoping imaging for different treatment sites. Both fluoroscopic images and 2-D plane images are saved in means for acquiring scanning information and for processing the information, such as a computer control system, and displayed in a monitor. If projection images are taken using techniques as described hereafter, cone-beam CT can be reconstructed also using the methods described hereafter. With limited projections, digital tomosynthesis images can be generated as referenced images.

In its broadest aspect, the system includes two pairs of x-ray source/detector combinations. Each x-ray tube is mounted against one x-ray detector (either flat panel detector or an image intensifier). One x-ray tube can be mounted in the gantry head. Two pairs of tube-detector combinations are typically mounted orthogonally on the gantry with respect to each other and rotate with the gantry. Alternatively, the angle can be as low as about 45° Conventional techniques of rejecting and minimizing scatter radiation are applied such as the use of an anti-scatter grid as placed in front of the detectors, and use of a Bowtie filter as placed in the front of x-ray tubes.

In implementing the scanning protocol, the x-ray beams can be turned on individually or turned on simultaneously or sequentially. This sequence is programmed and implemented by a control system. If the x-ray tubes are turned on simultaneously, an algorithm is implemented to reject scatter effects from one detector to another. For example, the signal detected can be recorded when the other x-ray tube is turned on. The noises can then be subtracted from the signal detected by its opposed x-ray tube.

In the case of SPECT imaging, the system allows simultaneous fluoroscopic imaging. The signal can be recorded individually and simultaneously. The recorded signals can be processed to display 3-D patient motion patterns and imaging processing methods, implemented in a conventional manner, and can be used to correct artifacts and enhance signals.

Yet still further, cone beams can be reconstructed on an individual basis on each detector/tube pair, a combination of tube pair detectors, for example at 90-180°s each, and interlaced using sandwiched projections sequences. Reconstruction can be effected for 180°-360° projections.

The algorithms implemented can be either analytical (such as backprojection techniques) or iterative such as multi-level scheme arithmetic iterative reconstruction methods). Additional digital tomosnythesis (DTS) can be generated for comparison to onboard CBCT in the treatment machine. DTS can be generated using projection images using each pair of tube/detector combinations. Alternatively, DTS can be generated using reconstructed CBCT. In such a case, reprojection will be done using CBCT images and DTS will be generated using reprojected projection images. DTS can be generated individually from each pair of x-ray tubes/detectors, or simultaneously by each pair of tube/detectors, at any angle with different projection numbers. In the case of dual-detector cone beams, CT simulators, treatment simulation is the first step for a cancer patient to be treated with high-energy radiation beams. Simulation is done using low energy photon beams to define how the actual treatment is performed. As already discussed, conventional and current CT simulation is with a single x-ray source with single or multiple slices. The deficiency of such a configuration is that it cannot be viewed simultaneously at 3-D formats for moving organs, which lacks 3-D information for moving organs and added longer simulation time. A monitoring device could be used and integrated to the imaging system to synchronize x-ray imaging device (on and off) with respiratory monitoring system.

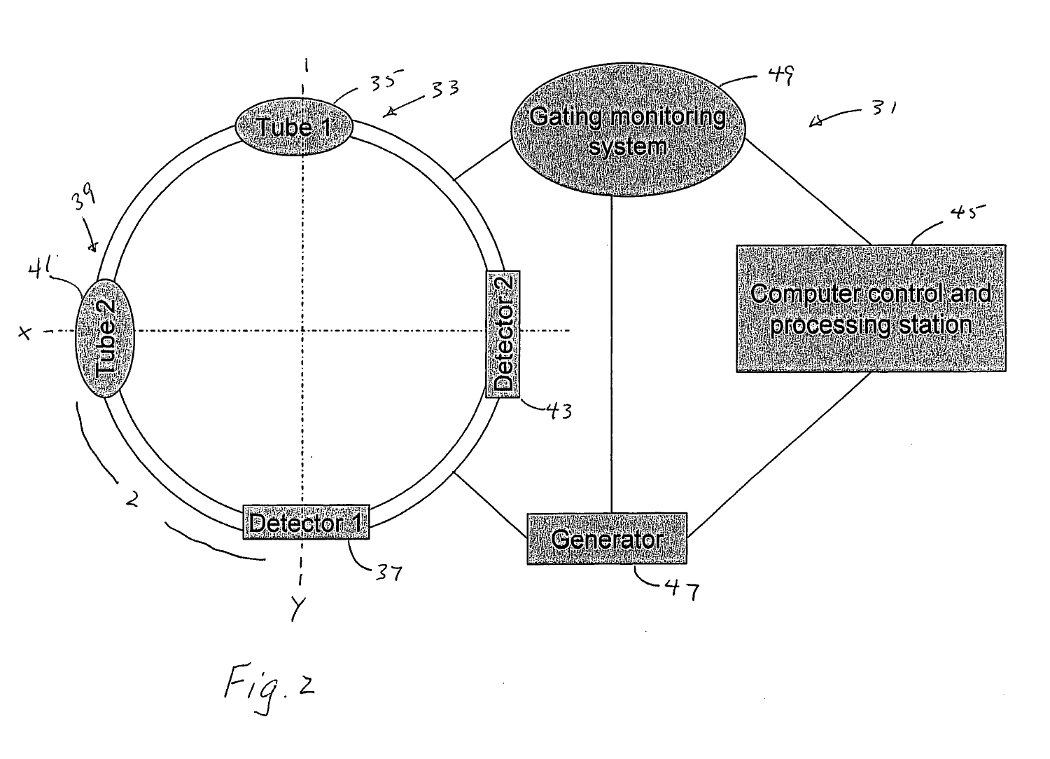

In accordance with this aspect of the invention, the system includes two pairs of x-ray tubes/detector combinations. A hardware configuration system hosts the two detectors and x-ray tubes, along with a control system. The detector and x-ray tube, as illustrated in FIG. 2, can rotate as fast as one second for rotation but the speed will be adjusted based on frame rate of the detector. Preferably, the pairs of x-ray sources and detectors are mounted orthogonally in a CT gantry and are covered as within conventional CT devices. The aperture for each x-ray tube can be adjusted using four independent leaves. The distance between x-ray tube and detector can be adjusted individually and can be different between two pairs. Software of computer algorithms could be implemented to correct detector artifacts and radiation scatter, etc.

In accordance with an implementation as contemplated herein, the system can be operated in three modes. A first mode is a plane imagining mode. In this mode, each individual image, orthogonal images can be taken individually or simultaneously. A second mode is fluoroscopic imaging. In this mode, low mAs will be used to generate fluoroscopic images either individually or simultaneously between two pairs of x-ray tubes/detector combinations. In tomographic imaging mode, either single pair of tubes/detector or combination of two pairs of detector/tubes can be used.

All three modes can be used for interventional radiology such as needle based biopsy and needle localization, such as orthogonal imaging. In addition, all other aspects specific to radiation therapy simulation described previously can also be implemented in the case of a dual detector cone beam CT simulator.

In yet still another aspect, the invention can be implemented in a dual detector arrangement in a room SPECT system. More specifically in the treatment room, a conventional treatment unit is a high energy photon beam with a portal imaging device. Additional features may be added to enhance localization accuracy, but use of kV x-ray tube and detectors orthogonally mounted to the treatment gantry. Such a device is used purely for treatment localizations and verification purposes. Such devices are not used for imaging or any functional activities.

In accordance with the invention, the detector is further modified for functional imaging purposes. Both detectors are replaced and implemented such that they detect photons emitting from the patient's body as a radiopharmaceutical agent is injected into the patient either by IV or injection into the tissue. Collimators with any types (such as used for conventional anger camera, etc.) are added to both detectors and a reconstruction algorithm implemented to reconstruct detected images.

More specifically, the system can be a pure SPECT system or a combination of a dual detector simulator for radiation therapy or as a dual detector CT simulator as previously described. In such a case, plane x-ray images, fluoroscopic images and CBCT images can be acquired in combination with SPECT images. The SPECT images can than be fused to the x-ray images, fluoroscopic images, and CBCT images using a conventional image registration technique. A display system then serves to display the images for review, analysis of anatomical and disease information, and for treatment planning purposes.

While the system described herein is specific to SPECT imaging, it will be appreciated by those or ordinary skill in the art that it can also be implemented with PET imaging. In the case of SPECT imaging, the detector used portal imager can be implemented as one commercially available from Varian. In the case of on-board PET imaging, four detectors are used. More specifically, two additional detectors are mounted near the x-ray tube and near the mV collimation. The detectors can be retracted when not used for PET imaging.

Alternatively, a conventional angle camera can be used as the detectors which can be mounted to the gantry or as an independent mobile device.

In the case of both SPECT and PET images, they can be acquired individually, or by combination of CBCT and SPECT and PET images. Since the images are acquired at the same patient location, SPECT and CBCT images can be fused. The same principles can be applied to PET/CBC images.

Again, as before, all specific implementations with respect to the four previously described system can also be implemented.

In the case of the SPECT/PET imaging system, a collimator may be added to the detector for an either flat panel detector or traditional angle camera. Energy resolution needs to be considered for the SPECT/PET imaging system, and one example includes the use of adding metal filters.

SPECT and PET images can be used to detect spatial and temporal changes of the functional elements of tumor or normal tissues such as hypoxia. They can also be used for targeted localization so that treatment radiation beam can be delivered on a real time adjusted basis based on functional information such as shown as onboard images. The dose can also be very calculated by the use of CBCT images which are fused to functional images such as PET or SPECT images.

That PET or SPECT images can also be used for treatment evaluation. If fusion of CBCT and PET or SPECT is desired, CBCT images are acquired first and can be used for correction of SPECT and PET images. Noise reduction can be achieved by modeling the noise of other detectors.

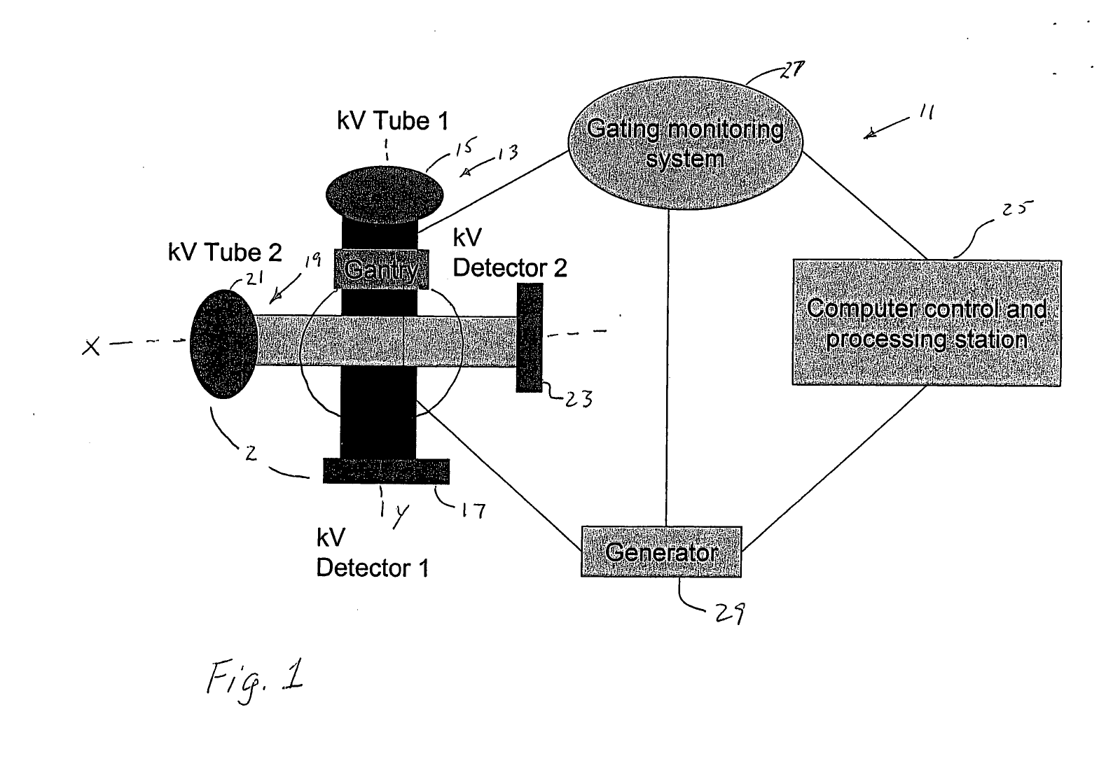

Having then thus generally described in specific details various aspects of the various embodiments of the invention, reference is now made to FIGS. 1 and 2.

FIG. 1 illustrates a dual detector simulator system 11. Such a simulator system 11 is used, for example, for simulations for radiation therapy in an open simulator device having, in the case of the invention, two x-ray tube and detector pairs 13 and 19. In the case of detector pair 13, then x-ray tube 15 such as is capable of emitting kV radiation is arranged along an axis y relative to a detector 17 passing through a space shown by a circle therein. A second tube/detector pair 19 is located at an angle 2 relative to the first tube/detector pair 13 along an axis x. The angle 2 is typically about 90° but can be as low as about 45°. Means such as computer control and processing station 25 serves to acquire and process images and control movement of the tube/detector pairs. A generator 29 serves to produce and control x-ray generation. A gating monitoring system 27 serves to monitor motion using sensors on the patient, outside the patient, etc., to ensure proper motion occurs. These devices are conventional and well known to those of ordinary skill.

FIG. 2 illustrates an exemplary embodiment of a dual detector CT simulator 31 in accordance with the invention. Means such as computer control and processing station 45 serves to acquire and process images and control movement of the tube/detector pairs. In accordance with the system of FIG. 2, two x-ray/source detector pairs 33 and 39 are arranged along axis x and y respectively at an angle 2 as described previously. The pairs 33 and 39 are arranged in a conventional CT gantry, which is typically a closed system and is implemented as previously described. A generator 47 serves to produce and control x-ray generation. A gating monitoring system 27 serves to monitor motion using sensors on the patient, outside the patient, etc., to ensure proper motion occurs. These devices are conventional and well known to those of ordinary skill.

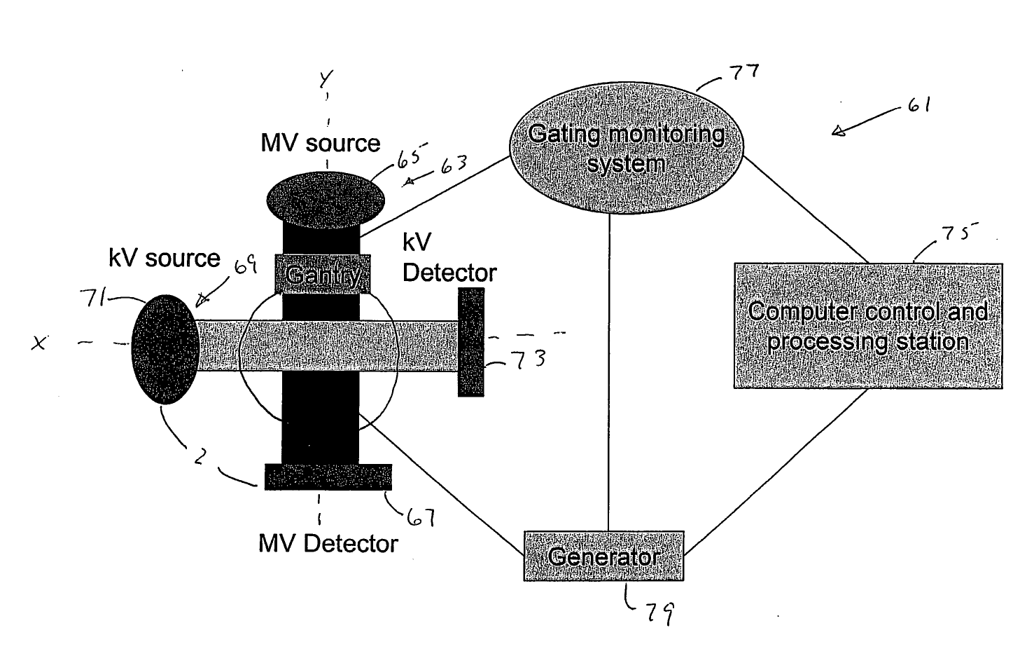

Referring to a SPECT system as previously discussed herein, such a system can be implemented with a system such as in FIG. 3. In such a case, the tube 71 along axis x can be a kV source and the tube 65 along axis y can be an mV source. The detectors 67 and 73 can be modified and implemented in the aforediscussed SPECT embodiment by panel detectors or other types well known to those of ordinary skill in the art as SPTECT or combination detectors. In such a case, a combination of different imaging techniques as previously discussed can be implemented herein. Means such as computer control and processing station 75 serve to acquire and process images and control movement of the tube/detector pairs. A generator 79 serves to produce and control x-ray generation. A gating and monitoring system 77 serves to monitor motion using sensors on the patient, outside the patient, etc., to ensure proper motion occurs. These devices are conventional and well known to those of ordinary skill.

Having previously discussed the invention in detail, the same will become better understood from the claims in which it is set forth in a nonlimiting manner.

What is claimed is:

1. A detector simulator for defining protocols for radiation treatment, comprising:
a first x-ray tube capable of emitting imaging radiation along one axis, and a first detector arranged opposite said first x-ray tube along said one axis;
a second x-ray tube capable of emitting imaging radiation along another axis different from said one axis, and a second detector arranged opposite said second x-ray tube along said another axis;
said one and another axes being in the same plane, and said first x-ray tube, first detector, second x-ray tube and second detector being arranged relative to each other for defining a space for a patient to be scanned by said first x-ray tube, first detector, second x-ray tube and second detector;
means for moving said first x-ray tube and first detector, and said second x-ray tube and second detector, as pairs, for scanning a patient placed in said space; and
means for acquiring scanning information about a patent and for processing said information to determine a treatment protocol for the patient.

2. The detector simulator of claim 1, wherein said means for moving is adapted for moving the first x-ray tube, first detector, second x-ray tube and second detector simultaneously.

3. The detector simulator of claim 1, wherein said one axis and said another axis are arranged at an angle of about 45° to about 90° relative to each other.

4. The detector simulator of claim 3, wherein said angle is about 90°.

5. The detector simulator of claim 3, wherein said angle is about 45°.

6. The detector simulator of claim 1, wherein said first x-ray tube and said second x-ray tube are kV x-ray tubes.

7. A detector simulator for computerized tomography (CT) imaging, comprising:
a CT gantry;
a first x-ray tube capable of emitting imaging radiation along one axis, and a first detector arranged opposite said first x-ray tube along said one axis;
a second x-ray tube capable of emitting imaging radiation along another axis different from said one axis, and a second detector arranged opposite said second x-ray tube along said another axis;
said one and another axes being in the same plane, and said first x-ray tube, first detector, second x-ray tube and second detector being arranged relative to each other for defining a space for a patient to be scanned by said first x-ray tube, first detector, second x-ray tube and second detector,
means for moving said first x-ray tube and first detector, and second x-ray tube and second detector, as pairs, for scanning a patient placed in said space; and
means for acquiring scanning information about a patient and for processing said information to determine a treatment protocol for the patient.

8. The detector simulator of claim 7, wherein said means for moving is adapted for moving the first x-ray tube, first detector, second x-ray tube and second detector simultaneously.

9. The detector simulator of claim 7, wherein said one axis and said another axis are arranged at an angle of about 45°.

10. The detector simulator of claim 7 wherein said angle is about 90°

11. The detector simulator claim 10, wherein said angle is about 45°.

12. A single photon emission computed tomography (SPECT) detector system, comprising:
a first x-ray tube capable of emitting imaging radiation along one axis, and a first detector arranged opposite said first x-ray tube along said one axis, and said first detector being capable of acquiring radiation from said first x-ray tube and photon emissions from a patient being scanned having at least one radiopharmacological agent injected therein;
a second x-ray tube capable of emitting imaging radiation along another axis different from said one axis, and a second detector arranged opposite said second x-ray tube along said another axis, and said second detector being capable of acquiring radiation from said first x-ray tube and photon emissions from said patient;
said one and another axis being in the same plane, and said first x-ray tube, first detector, second x-ray tube and second detector being arranged relative to each other for defining a space for said patient;
means for moving said first x-ray tube and first detector, and said second x-ray tube and second detector, as pairs, along said plane for scanning a patient placed in said space; and
means for acquiring scanning information about a patient and for processing said information to determine a treatment protocol for the patient.

13. The SPECT detector of claim 12, wherein said means for moving is adapted for moving the first x-ray tube, first detector, second x-ray tube and second detector simultaneously.

14. The SPECT detector claim 12, wherein said one axis and said another axis are arranged at an angle of about 45° to about 90° relative to each other.

15. The SPECT detector of claim 14, wherein said angle is about 90°.

16. The SPECT detector of claim 12, further comprising means for acquiring SPECT images as paired detectors for functioning imaging to localize tumors and monitor tumor changes during radiation treatment.

17. The SPECT detector of claim 12 further comprises means for acquiring organ motion images in combination with a motion monitoring device comprising at least a respiratory monitoring device, for recording 3-D organ motion and for correlating said organ motion images with x-ray images by synchronizing signals from said monitoring device and the imaging device.

18. The SPECT detector of claim 12 further comprising means for reconstructing tomographic images with at least one of a single detector, dual detector and a combination of single and dual detectors.

19. The detector simulator of claim 7, further comprising at least one of: means for SPECT imaging; means for interventional radiology for biopsy and fiducial implant; and means for dual fluoroscopic imaging;

20. The detector simulator of claim 7, further comprising means for sealing the detectors for allowing total movement of the detectors to occur in between about 1 to about 10 second intervals.
